(19) United States
(12) Patent Application Publication
(10) Pub. No.: US 2026/0326686 A1
(43) Pub. Date: Oct. 22, 2026

(54) CARRIER WITH INTEGRATED WIRE HARNESS

(71) Applicant: MAGNA CLOSURES INC., Newmarket (CA)

(72) Inventors: Milos PAVLOVIC, Newmarket (CA); Raymond Edward FORTIN, Newmarket (CA); James J. FERRI, Newmarket (CA)

(21) Appl. No.: 19/651,552

(22) Filed: Apr. 17, 2026

Related U.S. Application Data
(60) Provisional application No. 63/791,352, filed on Apr. 18, 2025.
(60) Provisional application No. 63/902,616, filed on Oct. 21, 2025.
(60) Provisional application No. 63/928,147, filed on Dec. 1, 2025.
(60) Provisional application No. 63/964,534, filed on Jan. 21, 2026.

(51) Int. Cl. B60R 16/02; B60J 5/04

(52) U.S. Cl. CPC B60R 16/0215; B60J 5/0413; B60J 5/0415

(57) ABSTRACT

A carrier for a carrier module of a motor vehicle door assembly having an inner panel and an outer panel defining a door panel structure with the inner panel having an opening to an internal door cavity between the inner and outer panels. The carrier has a body with opposite sides bounded by an outer periphery configured for attachment to the inner panel to substantially close off the opening. A binder is bonded to at least one of the opposite sides, and at least one wire is fixed to the body by the binder.

### CROSS-REFERENCE TO RELATED APPLICATIONS

This application claims the benefit of U.S. Provisional Application Serial No. 63/791,352, filed Apr. 18, 2025, and of U.S. Provisional Application Serial No. 63/902,616, filed Oct. 21, 2025, and of U.S. Provisional Application Serial No. 63/928,147, filed Dec. 1, 2025, and of U.S. Provisional Application Serial No. 63/964,534, filed Jan. 21, 2026, which are each incorporated herein by reference in their entirety.

### FIELD

The present disclosure relates generally to vehicle door assemblies, and more particularly to carrier modules therefor.

### BACKGROUND

This section provides background information related to the present disclosure which is not necessarily prior art.

It is known to fabricate carriers of automotive carrier modules from metal or plastic. The resulting carrier prevents debris and fluid from transferring from a wet side of the carrier module to a dry side of the carrier module. It is further known to attached electrical components and other features to the carrier, such as a window regulator, and further, to couple wires, such as a wire harness(es), to the electrical component(s). The electrical component(s) and wire harness(es) are attached to the carrier in multiple secondary operations, such as via mechanical fasteners, e.g. staples, clips, and tie wraps, with the wire harness(es), prior to being fixed to the carrier by the mechanical fasteners, typically being routed firstly in a labor intensive and time consuming operation by a person over a meandering, non-straight path in order to avoid interfering with the features and components of the carrier module. Although the aforementioned arrangement of carrier modules can be useful to perform their intended function, the multiple secondary manufacturing operations for construction and assembly of the wire harness(es) and other components to the carrier by a person, along with having to route the wire harness(es) over a non-straight path, are labor intensive, time consuming, and prone to variability, which can impact an ability to produce a product that is reliable in use, as well as adding complexity and adding cost to the manufacture process.

In view of the above, there is a need to provide a carrier that can readily perform desired structural and barrier functions, and that enhances economies of manufacture and assembly, while reducing weight to enhance fuel economy of the vehicle.

### SUMMARY

This section provides a general summary of the disclosure and is not intended to be considered a complete and comprehensive listing of the disclosure’s full scope or all of its aspects, advantages, objectives and/or features.

It is an object of the present disclosure to provide a carrier for a carrier module of a door assembly of a motor vehicle that addresses at least those issues discussed above of known carriers.

In accordance with an aspect of the disclosure, a carrier for a carrier module of a motor vehicle door assembly having an inner panel and an outer panel defining a door panel structure with the inner panel having an opening to an internal door cavity between the inner and outer panels is provided. The carrier has a body, with opposite sides of the body being bounded by an outer periphery configured for attachment to the inner panel to substantially close off the opening. A binder is bonded to at least one of the opposite sides, and at least one wire is fixed to the body by the binder.

In accordance with another aspect of the disclosure, the body is formed from non-synthetic material

In accordance with another aspect of the disclosure, the body is formed of a sustainable material to render the body being environmentally friendly.

In accordance with another aspect of the disclosure, the at least one wire is entirely encapsulated beneath an exposed surface of the binder, thereby being protected against damage, while also being out of the way from obstructing placement and assembly of other components, with the exception of at least one location of the at least one wire where the at least one wire is electrically connected to an electrical component.

In accordance with another aspect of the disclosure, the at least one wire is not visible or able to be physically touched, with the exception in the at least one location where the at least one wire is electrically connected to an electrical component, thereby being protected against damage, while also being out of the way from obstructing placement and assembly of other components.

In accordance with another aspect of the disclosure, the body has at least one undulating contoured region, including a plurality of recessed pockets, wherein the at least one wire is routed through the undulating contoured region to follow the undulating contoured region in embedded relation with the binder, thereby avoiding having to route the at least one wire around an outer periphery of the undulating contoured region.

In accordance with another aspect of the disclosure, the at least wire follows a generally straight path along the undulating contour, thereby minimizing complexity and simplifying manufacture of the carrier by not having to route the at least one wire around pockets of the undulating contour intended for receipt of components therein.

In accordance with another aspect of the disclosure, the at least one wire is a wire harness having a substrate, wherein the substrate is fixed to the body by the binder.

In accordance with another aspect of the disclosure, the problems associated with known carriers, such as those discussed above in the Background, are solved by introducing a wire harness construction and integration method of attachment to a carrier, disclosed herein, that utilizes an automated process, such as a CNC-type process, by way of example and without limitation. The automated process includes pre-assembling one or more wire harnesses, including electrical conductors, such as wires, on a substrate. The substrate or the wire harness is constructed to hold the electrical conductor(s) securely throughout manufacturing and facilitate autonomous installation of the wire harness on the carrier or carrier module. The wire harness, upon being pre-assembled, is transferred to, or along, an assembly line, where the wire harness is disposed on the carrier via a robotic apparatus, forming a semi-permanent connection of the wire harness(es) to the carrier. The wire harness(es) has one or more connectors, which are orientated in a preset directional orientation to enable autonomous mating connections to other electrical components, thereby significantly reducing manual labor, assembly time, and the need for fastening components such as clips or harness wraps.

The disclosure further involves providing the substrate having openings, also referred to as holes or apertures, allowing flow of a bonding agent, such as polyurethane (PU) material, by way of example and without limitation, through the openings of the wire harness substrate to mechanically secure the wire harness to the carrier or module upon cooling and solidification of the bonding agent. This process employs a low-temperature (approximately 80°C) operation that prevents thermal damage to sensitive components, such as electronic control units (ECUs) and display control units (DCUs). The substrate can be pre-formed to precisely match the carrier shape, enabling a seamless fit during assembly. The low-temperature process can include a spray transfer press operation, by way of example and without limitation.

In accordance with another aspect of the disclosure, a method of assembly of a carrier or module offers unlimited variants, minimizes part counts, improves indoor packaging, and supports a variety of configurations, including the integration of electronic components/modules directly within the wire harness as a replacement for traditional plastic casings. The methods of assembly disclosed herein eliminate the need for secondarily applied clips, wraps, and molded-in fixtures, simplifies the assembly process, and enhances overall manufacturing efficiency of a carrier and module therewith.

In accordance with a further aspect of the disclosure, provided is a module for a vehicle door including a carrier configured to be received in a cavity of a vehicle door and to support door hardware including at least one of a window regulator, a window glass run channel, a pulley, a speaker, and a door latch, an electrical harness including a plurality of electrical conductors and at least one electrical connector, a substrate carrying the electrical conductors, the substrate being positioned on the carrier and defining guide features for the electrical conductors, and a binder material connecting the substrate to the carrier.

In accordance with another aspect of the disclosure, the electrical conductors are secured to the substrate prior to assembly of the substrate on the carrier.

In accordance with another aspect of the disclosure, binder material is applied in a flowable state at a low temperature and, during a pressing operation, flows from one side of the substrate through one or more openings in the substrate and over an opposite side of the substrate so that, after undergoing a state change from a liquid state to a hardened, solidified state, the binder material mechanically interlocks with the substrate to fix the wire harness in place relative to the carrier.

In accordance with another aspect of the disclosure, the guide features of the substrate are arranged to orient the at least one electrical connector with a mating axis accessible in a cross-vehicle direction.

In accordance with another aspect of the disclosure, at least some of the openings comprise edge opening notches that openly connect each opening to a side edge of the substrate to permit local elastic enlargement of the opening and to allow a hardened stem of the binder material to pass through the notch during installation and disassembly, thereby facilitating the ease of assembly and facilitating an ability to reclaim and recycle metal of the wire(s).

In accordance with another aspect of the disclosure, the binder material comprises polyurethane (PU) applied in a flowable state at a temperature of about 80°C and cured by cooling to the hardened state.

In accordance with another aspect of the disclosure, the binder material is applied to the carrier and the substrate during a low temperature stamping or pressing operation, wherein the carrier is contoured to a final contour during the pressing operation, and wherein the carrier is free of any injection molding operation for securing the wire harness to the carrier.

In accordance with another aspect of the disclosure, the carrier comprises a fiber sheet formed from an environmentally sustainable material selected from the group consisting of jute, basalt, and hemp, impregnated with the binder material.

In accordance with another aspect of the disclosure, the substrate is preformed to match a three-dimensional surface contour of the carrier to establish a conformal interface between the substrate and the carrier.

In accordance with another aspect of the disclosure, the substrate comprises preformed shapes and holes constituting guide and attachment features that establish the routing and anchoring positions of the electrical conductors to the substrate and anchoring positions of the substrate to the carrier.

In accordance with another aspect of the disclosure, the substrate further includes conductor receiving channels having undercut retention features configured to mechanically retain the electrical conductors within the channels prior to application of the binder material.

In accordance with another aspect of the disclosure, the substrate is a multilayer laminate and at least a portion of the electrical conductors are enclosed between a first layer and a second layer of the multilayer laminate.

In accordance with another aspect of the disclosure, an electronic control unit (ECU) or door control unit (DCU) is captured between the first layer and the second layer of the multilayer laminate substrate.

In accordance with another aspect of the disclosure, at least one of the electrical connectors is oriented in inclined relation, such as perpendicular, to a plane of the carrier to present a mating axis in a cross-vehicle direction for autonomous installation.

In accordance with another aspect of the disclosure, the hardened binder material defines mushroom-shaped or enlarged, flared heads on a side of the substrate opposite the carrier after flowing through the openings to mechanically interlock the substrate to the carrier.

In accordance with another aspect of the disclosure, a door node controller is mounted to the wire harness, wherein the door node controller is sealed within the wire harness.

In accordance with another aspect of the disclosure, positions of the electrical connectors and electronic modules on the substrate are selected to be accessible to a robotic manipulator for autonomous mating during vehicle assembly.

In accordance with another aspect of the disclosure, the wire harness is secured to the carrier without discrete harness clips, harness wraps, or molded doghouses.

In accordance with another aspect of the disclosure, the polyurethane binder material is deposited by a spray application and subsequently pressed to urge the binder material through the openings in the substrate before curing the binder material.

In accordance with another aspect of the disclosure, the carrier comprises thermoplastic attachment posts that extend through the openings of the substrate, with the attachment posts having thermally flared heads formed after a heated pressing operation to clamp the substrate to the carrier via the thermally flared heads.

In accordance with another aspect of the disclosure, the carrier and the wire harness secured thereto form a pre-assembled door module configured to be installed as a unit into the vehicle door cavity.

In accordance with another aspect of the disclosure, a method of manufacturing a carrier of a carrier module for a motor vehicle door panel structure for closing off an opening in an inner panel of the motor vehicle door panel structure is provided. The method includes providing a body formed from non-synthetic material, having opposite sides bounded by an outer periphery configured for attachment to the inner panel to substantially close off the opening. Further, providing at least one wire, and fixing the at least one wire to at least one of the opposite sides of the body with a binder material.

In accordance with another aspect of the disclosure, the method can further include laying the at least one wire along the at least one side and then applying the binder material to the at least one side.

In accordance with another aspect of the disclosure, the method can further include avoiding applying the binder material to at least one location where the at least one wire is to be electrically connected to an electrical component.

In accordance with another aspect of the disclosure, the method can further include applying the binder material to the at least one side and then pressing the at least one wire along the at least one side into the binder material.

In accordance with another aspect of the disclosure, the method can further include pressing the body between a pair of plates and causing the body to attain a non-planar contour.

In accordance with another aspect of the disclosure, the method can further include heating the body and the binder material between the plates to a temperature between about 70-90 ^{o}C.

In accordance with another aspect of the disclosure, the method can further include avoiding stretching the at least one wire between the pair of plates while pressing the body.

In accordance with another aspect of the disclosure, a method of manufacturing a carrier or carrier module for automotive doors comprises the steps of laying out wires onto a substrate to form a harness using CNC or similar machinery, forming the substrate with pre-defined shapes and holes, and then performing a bonding step by spraying a low-temperature bonding material through the holes to secure the substrate and relative to a body of the carrier or carrier module.

In accordance with another aspect of the disclosure, the method can further include pre-shaping the substrate to match the contour of the carrier or module before integrating the harness, to enable a precise, uniform fit during assembly.

In accordance with another aspect of the disclosure, the method can further include performing the bonding step by inserting the harness into a stamping or pressing tool that mechanically bonds the harness to the carrier or module during processing.

In accordance with another aspect of the disclosure, the method can further include performing the bonding step at a temperature of approximately 80°C to avoid damage to electronic components attached to the harness.

In accordance with another aspect of the disclosure, a method of forming a carrier or carrier module for a vehicle comprises the steps of: supplying a sheet of material; positioning a hardware component relative to the sheet of material; applying a binding agent in contact with the sheet of material and the hardware component while the binding agent is in a flowable first physical state; and changing the flowable first physical state of the binding agent to a solidified second physical state to secure the hardware component on the sheet of material.

In accordance with another aspect of the disclosure, the method can further include causing the binding agent, while in the flowable first physical state, to at least partially surround the hardware component.

In accordance with another aspect of the disclosure, the method can further include providing the sheet of material formed from an environmentally sustainable material.

In accordance with another aspect of the disclosure, the method can further include positioning the hardware component and sheet of material in a press and bringing the sheet of material, the hardware component and the binding agent in compression with one another using the press when the agent is in the first state.

In accordance with another aspect of the disclosure, a method of forming a carrier or carrier module for a vehicle comprises the steps of: providing a thermoplastic body having attachment features; positioning a hardware component adjacent to the attachment features while in a first non-locking shape, and changing shape of the attachment features to a second locking shape to prevent the hardware component from separating from the body.

In accordance with another aspect of the disclosure, the method can further include changing shape of the attachment features to the second locking shape in a heated pressing operation.

In accordance with another aspect of the disclosure, the method can further include providing the first non-locking shape having a generally straight pillar shape; extending the generally straight pillar shape through an opening of the hardware component, and forming the second locking shape having an enlarged flange extending radially outwardly from the generally straight pillar shape in overlying relation with the hardware component to capture the hardware component against removal from the thermoplastic body.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 is a schematic perspective view of a door assembly of for a motor vehicle having a carrier module in accordance with an aspect of the disclosure;

FIG. 2A is a view of a pair of press plates used in a pressing process, with the press plates shown in an open position and further showing a binder applicator for manufacturing a carrier in accordance with an aspect of the disclosure;

FIG. 2B is a view similar to FIG. 2A of showing the pair of press plates and the binder applicator for manufacturing a carrier in accordance with another aspect of the disclosure;

FIG. 2C shows a schematic view illustrating a sequential series of steps of a spray transfer process and pressing process, such as discussed above for FIGS. 2A and 2B, with continuous sheet of body material coming from a roll, e.g. a 3ft or 5ft roll, being transferred to a binder spray process and subsequently to a press with top press plate and lower press plate, subjecting wire(s) to a pressure of e.g. 200 tons;

FIG. 3 illustrates a fragmentary side cross-sectional view of a carrier having a wire harness integrated therewith in accordance with an aspect of the disclosure shown configured for electrical attachment to an electrical component;

FIG. 4 illustrates plan view of a carrier having a wire harness integrated therewith in accordance with another aspect of the disclosure;

FIG. 5A is a perspective fragmentary view of a carrier with a wire harness integrated therewith in accordance with another aspect of the disclosure;

FIG. 5B is a cross-sectional view of the carrier of FIG. 5A illustrating a mechanical fixation of the wire harness with a body of the carrier in accordance with another aspect of the disclosure;

FIG. 6A is a plan view of a wire harness having a sealed integrated control module disposed between substrate layers in accordance with another aspect of the disclosure;

FIG. 6B is a perspective view of the wire harness of FIG. 6A shown integrated with a carrier in accordance with another aspect of the disclosure, with a plurality of electrical component shown exploded from the carrier for direct attachment to electrical connectors of the wire harness;

FIG. 7 shows a method of manufacturing a carrier with an integrated harness in accordance with another aspect of the disclosure; and

FIGS. 8A through 8E show a method of manufacturing a carrier with an integrated harness in accordance with yet another aspect of the disclosure.

### DETAILED DESCRIPTION OF EXAMPLE EMBODIMENTS

In general, example embodiments of a door assembly with carrier module and carrier module therefor, of the type configured including window regulators to be installed within an internal door cavity of a motor vehicle door assembly and configured to separate a wet side from a dry side of the door assembly, constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

An example one-piece carrier module embodiment disclosed in accordance with one aspect of the disclosure includes a carrier having pre-integrated wires, wherein the wires are encapsulated in bonded relation to the carrier, with the wires having exposed attachment portions that allow a window regulator and other electrical components to be coupled in electrical communication with the wires.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element’s or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

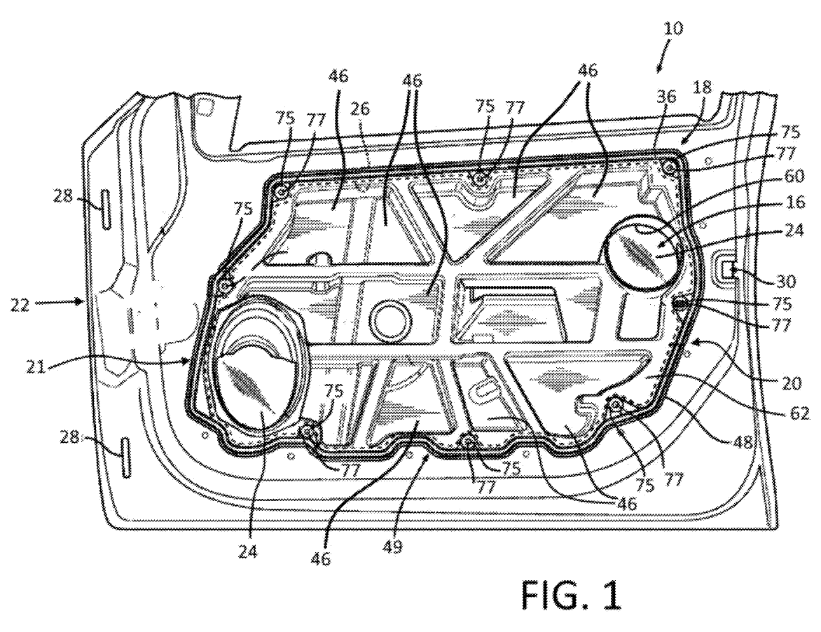

Reference is made to FIG. 1, which shows a door assembly 10 constructed to be mounted to a vehicle body of a motor vehicle. The door assembly 10 includes an outer panel 16, an inner panel 18 and a carrier assembly, referred to hereafter as carrier module 20, having a carrier 21 constructed in accordance with aspects of the disclosure. The manufacture, assembly, reduced weight, performance and integrated electrical members of the door assembly 10 are enhanced directly as a result of the structure and method of assembly of the carrier 21. It will be appreciated by the skilled artisan that the carrier module 20 and carrier 21 thereof can be incorporated into a rear passenger door assembly or any other closure panel desired.

The outer panel 16 forms at least part of the exterior surface of the door assembly 10. The inner panel 18 provides a structural member for the mounting of one or more trim pieces that form an inner surface of the door assembly 10. Some of the inner panel 18 may itself also form part of the inner surface of the door assembly 10, if desired. The outer panel 16 and inner panel 18 are connected together to provide a door panel structure 22 that forms an internal door cavity 24 that contains various components of the door assembly 10, including components of the carrier module 20. To facilitate assembly of the components into the cavity 24, the inner panel 18 has at least one opening 26. The opening 26 is sized to allow access to the cavity 24 as necessary and desired for assembly and service of components therein, as is known.

The outer and inner panels 16, 18 may be made from any suitable material or combination of materials. For example, the outer and inner panels 16, 18 may both be made from a suitable metal (e.g. a suitable steel). In another example, the outer panel 16 may be made from a suitable polymeric or composite material (e.g. fiberglass) and the inner panel may be made from a suitable metal, by way of example and without limitation.

A pair of hinges 28 are connected to door panel structure 22 and pivotally mount a front end of door panel structure 22 (and door assembly 10) to the vehicle body. A door latch 30 is mounted to the rear end of door panel structure 22 to permit the releasable closure of door assembly 10 against vehicle body, as is known. Hinges 28 and door latch 30 act as force transfer members through which forces in door assembly 10 are transmitted to the vehicle body. Such forces include, for example, side-impact forces from another vehicle or object colliding with the vehicle.

Carrier 21 is shown as being configured for sealed mounting to inner panel 18 and to support a at least one door hardware component, such as window and door latch components, including a power-operated window regulator having an electric motor-driven cable, pulleys, and lifter plates for moving a window within glass run channels, by way of example and without limitation, as will be understood by one possessing ordinary skill in the vehicle door assembly art. Examples of hardware components is shown and described in US9731581B2 titled “Vehicle door and door module with multi-portion door carrier”, the entire contents of which are incorporated herein by reference.

In accordance with a non-limiting embodiment, carrier 21 can be formed to function both as a fluid (water and moisture) barrier and as a sound barrier, and can be provided as a single-piece panel configured to receive a plurality of the aforementioned powered actuators and door hardware components in integrally formed contoured pockets. The carrier 21 can be adapted to be installed in fixed attachment to a surface of the inner panel 18 facing the passenger compartment of the vehicle upon fixing the various components, such as those discussed above, in the internal door cavity 24. Further, in order to facilitate assembly, including ensuring the carrier 21 is properly located and fixed in sealed relation relative to the inner panel 18, the carrier 21 can be formed including a peripherally extending seal bead 36. The seal bead 36 can be provided as any suitable continuous bead of adhesive material capable of maintaining a fluid-tight seal between the carrier 21 and an outer surface of the inner panel 18, such as butyl, by way of example and without limitation. A selectively removable protective layer, sometimes referred to as release paper or release film, and referred to hereafter as release member, can be disposed over the seal bead 36 until it is desired to expose the seal bead 36 for bonding with the inner panel 18, thereby protecting the seal bead 36 against unwanted contamination.

Carrier 21 has a carrier body, also referred to as body 49, formed from a recyclable, environmentally sustainable (the quality of not being harmful to the environment or depleting natural resources, and thereby supporting long-term ecological balance), biodegradable material, such as from natural fibers of natural fibrous material(s). One example construction of carrier 21 is shown in US Patent No. US11951816 titled “Vehicle door with carrier module having sustainable carrier”, the entire contents of which is incorporated by reference herein. Furthermore carrier 21 can be formed including sustainable and renewable materials, such as plant fibers and rock fibers. The carrier 21 of the present embodiment is distinguished from carriers formed from non-sustainable and non-renewable materials such as petroleum based materials requiring man-made chemical processes, such as chemical synthesis for example, to create forms of synthetic materials and synthetic fibers such as polymers and plastics, such as thermoplastics, for forming a carrier via injection molding. Some well suited natural fibrous materials include various types of natural fibers, for example plant based fibers, such as bast fibers, cellulosic fibers, cane fibers, including kenaf, hemp, flax, bamboo, and jute, by way of example and without limitation. Such materials may be derived from plants or rocks for example. Other examples of natural fibrous materials may also be a rock based material, such as basalt fibers. Further, being made entirely or substantially (nearly entirely, such as between 90-99.9 percent-by-weight (%/wt), and more preferably between 95-99.9 %/wt, the carrier 21 is lightweight (20 percent of lighter than a similarly sized and shaped carrier of polypropylene), has high strength, particularly if the natural fibrous material is kept dry, is 100% recyclable, 100% renewable, and 100% biodegradable, has a low content of volatile organic compounds (VOC) and is formaldehyde free, functions excellent as acoustic insulation, and exhibits a high heat stability up to temperatures of 220 degrees Centigrade (^{o}C).

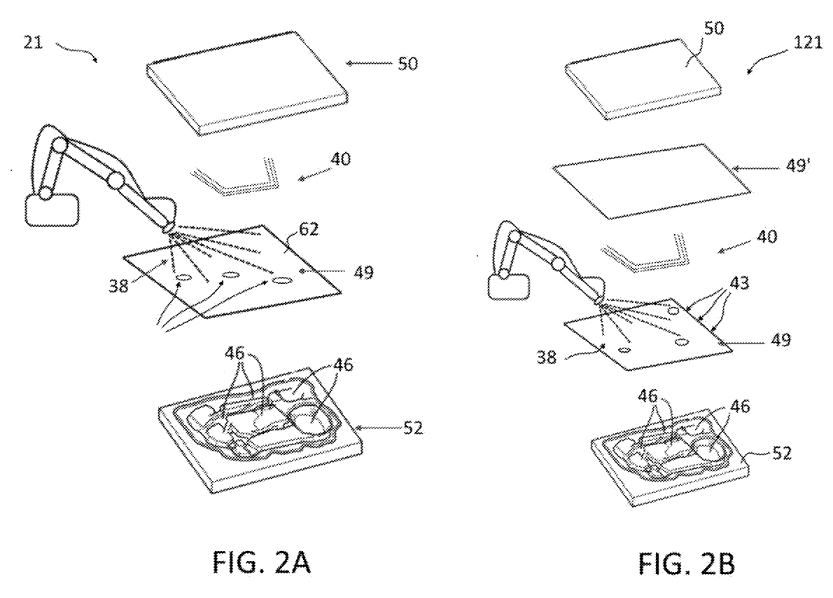

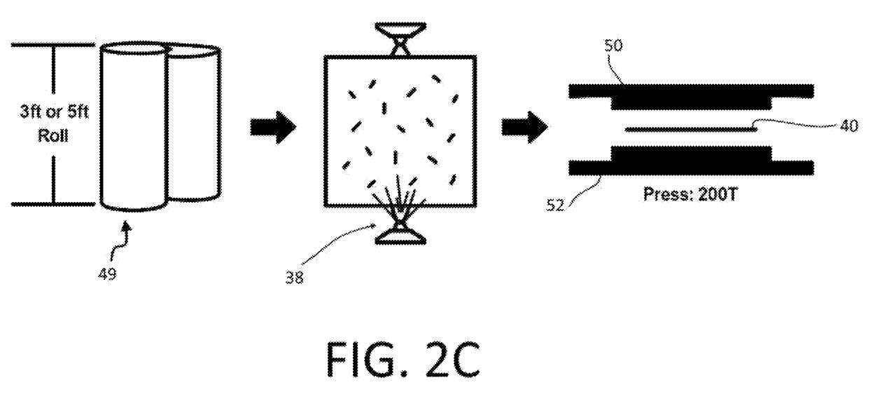

Body 49 of carrier 21 has opposite sides, including a wet side 60 and a dry side 62 (FIG. 2A), bounded by outer periphery 48. Body 49, aside from being formed of the aforementioned natural fibers of natural fibrous material, in a non-limiting embodiment, can include a binder additive, also referred to as binder agent or binder, wherein binder facilitates bonding the natural fibers of natural fibrous material together. Binder can be provided as an additive in a web forming process, such as an air-laying process, by way of example and without limitation, whereupon web can be subjected to a suitable heat-treatment process to causes binder to melt and bond the natural fibers within web together. In addition to applying heat to melt binder, the web can be subjected to pressure, such as in a compression molding, also referred to as compression pressing or pressing process (FIGS. 2A and 2B). Compression molding process utilizes a mold assembly having a male mold half, also referred to as male plate or top press plate 50 and a female mold half, also referred to as female plate or lower press plate 52. Top press plate 50 includes outwardly extending protrusions (not shown) and lower press plate 52 includes pockets 46, wherein protrusions of top press plate 50 and pockets 46 of lower press plate 52 mirror and mate with one another in nesting relation to form the desired non-planar, undulating contour features of carrier 21. It is contemplated that the binder can be provided to bond the natural fibers of natural fibrous material together without heat, wherein binder can be provided as a suitable adhesive.

Body 49 can be formed having a plurality of fastener through openings 75 adjacent the outer periphery 48 and further including a metal or plastic grommet 77 fixed in each of the plurality of fastener through openings 75. Grommets 77 provide compressive structural support for receipt of fasteners used to fix carrier 21 to inner panel 18, wherein grommets 77 prevent over-compression and tearing of the natural fibrous material.

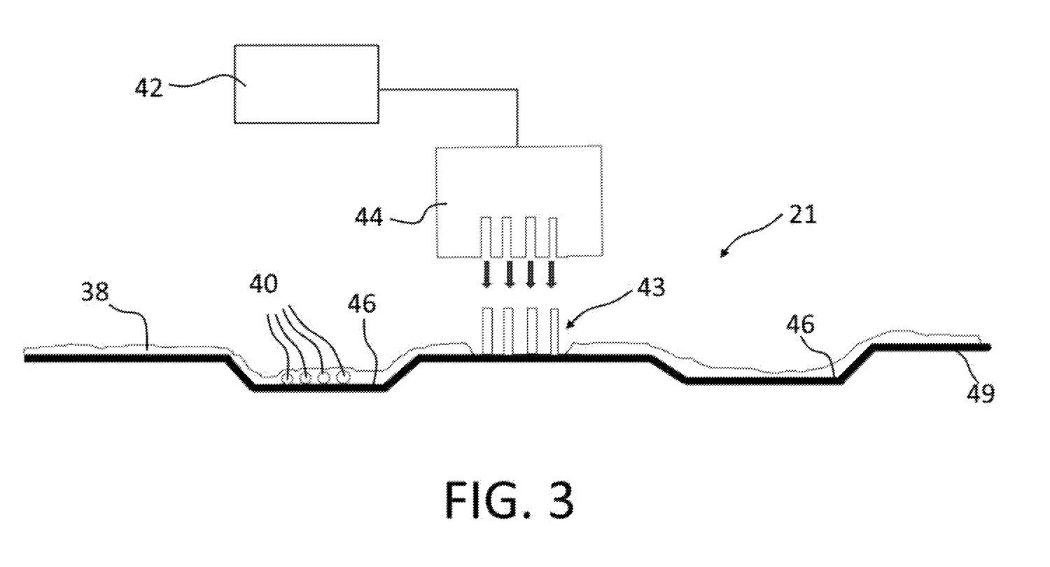

A binder agent, also referred to as binder 38, such as polyurethane (PU), by way of example and without limitation, is bonded to at least one of the opposite sides 60, 62. The binder 38 fixes at least one electrical conductor, such as a wire, and shown as a plurality of wires 40, by way of example and without limitation, to the body 49. The wire(s) 40 is entirely encapsulated by the binder 38, with the exception of at least one location 43 (FIG. 3), such as at end connections to an electrical component 42 and/or at one or more intermediate electrical junctions 44, such that the wire(s) 40 can be arranged for electrical connection to one or more electrical component(s) 42, whether at the ends or between the ends at the intermediate junctions 44. Where the wire(s) 40 is covered and encapsulated by the binder 38, the wire(s) 40 is not visible, assuming the binder 38 is not translucent, but in any event, the wire(s) 40 is not able to be touched. Accordingly, the wire(s) 40 is only visible and/or capable of being touched at the location(s) 43 where the at least one wire 40 is electrically connected to an associated electrical component 42. As such, the wire 40 does not need to be provided having a traditional external protective sheath, thereby doing away with cost and bulkiness of a standard sheathed wire or sheathed wire harness. In addition, with the wire(s) 40 being essentially buried within the binder 38, an outer surface of the binder 38 remains flat and planar. The body 49, as best shown in FIGS. 1 and 3, can be formed having an undulating contour, including a plurality of recessed pockets 46, wherein the wire(s) 40 can follow the undulating contour through an associated pocket 46 in embedded relation within the binder 38. The undulating contour and transitions thereof can be smooth, without sharp edges or corners, thereby allowing the wire(s) 40 to be disposed within the binder 38 and caused to follow the undulating contour during pressing without causing the wire(s) 40 to be stretched and damaged. Accordingly, any component disposed within the associated pocket 46 can occupy the fully volume of the pocket 46 without hindrance or interference with the wire(s) 40, and without fear of the wire(s) 40 being damaged. Accordingly, the wire(s) 40 is able to function without concern of physical interference or damage from the component disposed in the pocket 46. With the wire(s) 40 being embedded beneath the exposed outer surface of the binder 38, the wire(s) 40 can follow a generally straight path, as viewed in a top plan view of the body 49, including extending through the pocket 46 of the undulating contour, thereby minimizing the amount of costly copper typically used for the wire(s) 40 by not having to be routed around the pocket 46’, thus, reducing the cost associated therewith.

In FIG. 2B, an alternate embodiment is illustrated, wherein a carrier 121 resulting therefrom includes a pair of bodies 49, 49’ laminated and bonded together by the binder 38. As a result, the wire(s) 40 are captured in sandwiched relation between the pair of bodies 49, 49’. It is to be understood that one or both bodies 49, 49’ can be formed with through openings, such as at locations 43, as needed, to provide access for electrical connection of wire(s) 40 to the desired electrical component, as discussed above for carrier 21.

A method of manufacturing a carrier 21 of a carrier module 20 for a motor vehicle door panel structure 22 for closing off an opening 26 in an inner panel 18 of the motor vehicle door panel structure 22 is provided to keep moisture and fluid from passing from a wet side of carrier module 20 to a dry side of carrier module 20. The method includes a step of providing a body 49 formed from non-synthetic material and having opposite sides 60, 62 bounded by an outer periphery 48 configured for attachment to the inner panel 18 to substantially close off the opening 26. Further, a step of providing at least one wire 40 and a step of fixing the at least one wire 40 to at least one of the opposite sides 60, 62 of the body 49 with a binder 38.

The method can further include a step of laying the at least one wire 40 along the at least one side 60, 62 and then applying the binder 38 to the at least one side.

The method can further include a step of avoiding applying the binder 38 to at least one location 43 where the at least one wire 40 is to be electrically connected to an electrical component 42.

The method can further include a step of applying the binder 38 to the at least one side 60, 62 and then pressing the at least one wire 40 along the at least one side into the binder 38.

The method can further include a step of pressing the body 49 between a pair of plates 50, 52 and causing the body 49 to attain a non-planar contour.

The method can further include a step of heating the body 49 and the binder 38 between the plates 50, 52 to a relatively low temperature between about 70-90 ^{o}C to facilitate bonding and curing of the binder 38, and to avoid causing thermal damage to the at least one wire 40.

The method can further include a step of avoiding stretching the at least one wire 40 between the pair of plates 50, 52 while pressing the body 49 between the plates.

The method can further include sandwiching the at least one wire 40 between a pair of bodies 49, 49’ during the pressing step and bonding the pair of bodies 49, 49’ to one another with the binder 38.

The method can further include providing at least one of the pair of bodies 49, 49’ with at least one through opening to facilitate forming an electrical connection between the wire(s) 40 and an associated electrical component 42.

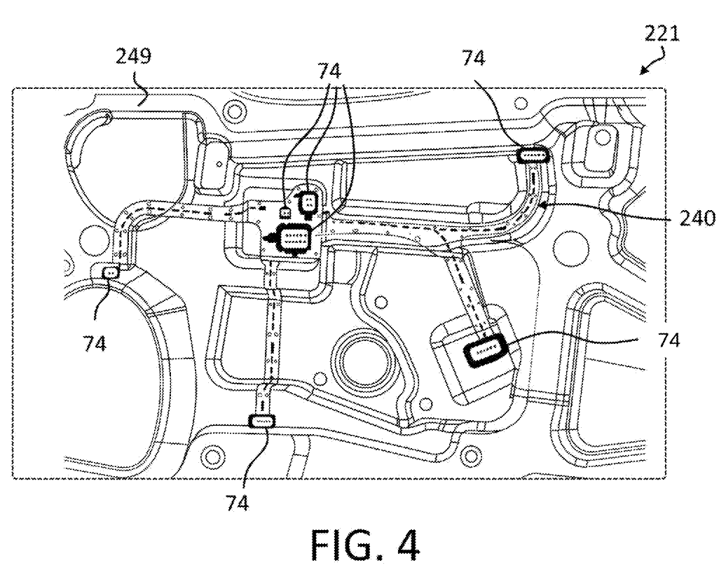

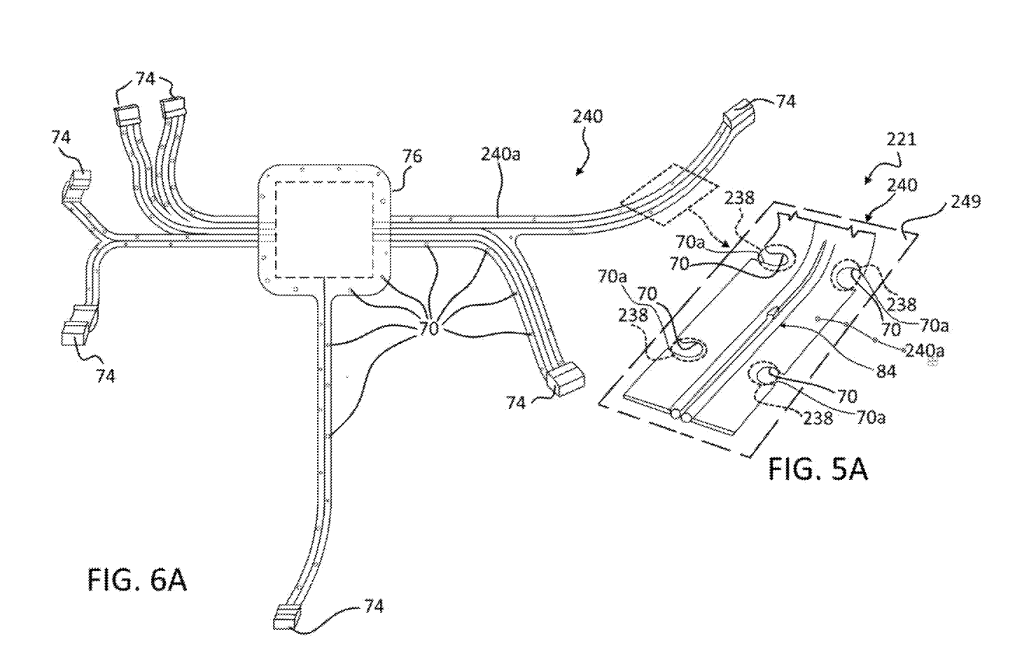

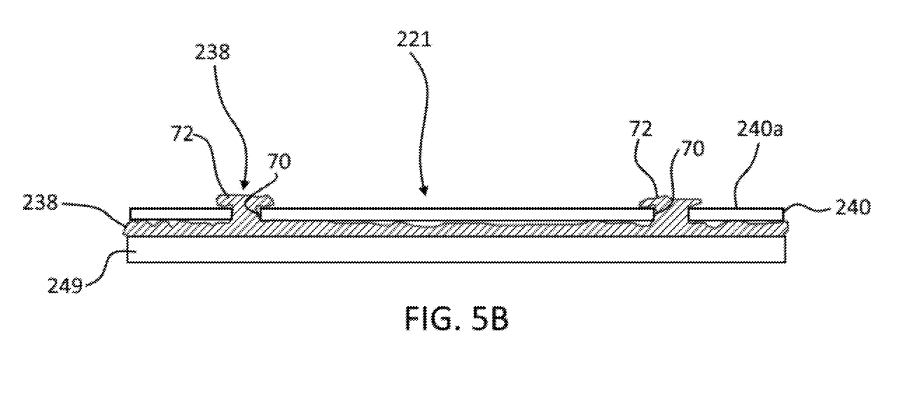

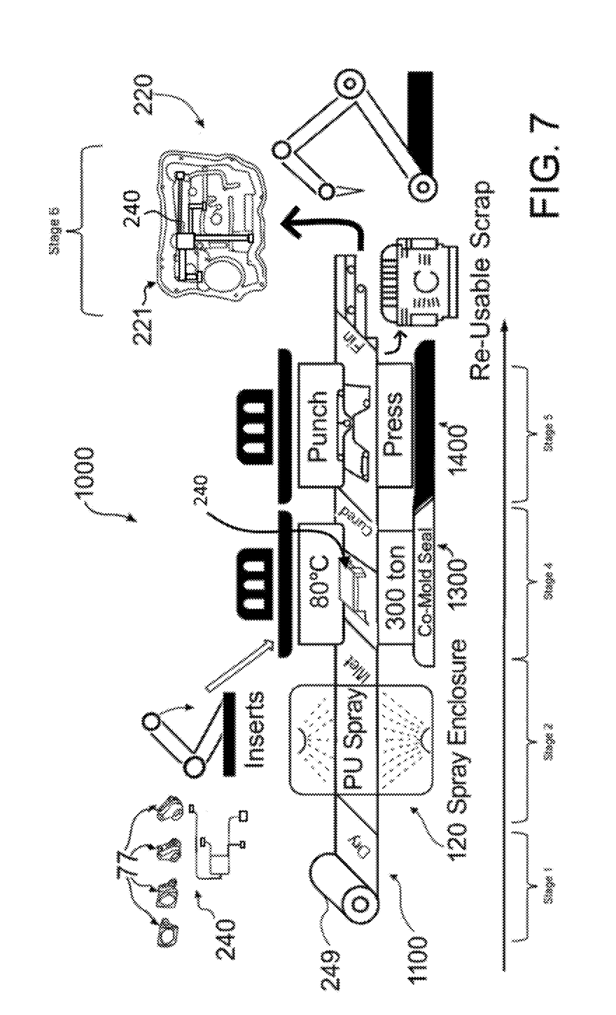

A carrier 221 constructed in accordance with another aspect of the disclosure is shown in FIGS. 4-5B. Carrier 221 has an electrical member, shown as a wire harness 240, including a substrate, also referred to as sheath 240a, having a laterally extending flange, also referred to as flared footing, at least partially or entirely encased around one or more wire(s) 240b (best shown in FIG. 5A) of the wire harness 240 to lock or secure the wire(s) 240b in integrated fashion with another substrate, also referred to as body 249, of the carrier 221. The sheath 240a may be designed with pre-formed shapes and/or holes 70 as guide or attachment features that facilitate positioning and mechanical connection of the wire harness 240 to the body 249, such as via a physical state change material, referred to as binder material 238, fixing the wire harness 240 to the body 249, whether via a separate material from the body 249 or of material of the body 249 itself. The holes 70 may be formed in the flared footing of sheath 240a, for example. During manufacturing, the wire harness 240 is laid out using CNC or similar numerically controlled machinery, with the wires 240b secured to the sheath 240a to maintain their position, and with a first surface, also referred to as first side, of the sheath 240a facing the body 249 and an opposite second surface, also referred to as second side, of the sheath 240a facing away from the body 249. Holes 70 in the sheath 240a allow material of the carrier 221, if fabricated from other than an environmentally sustainable material, or of a separate binder material 238, such as polyurethane, by way of example and without limitation, to flow therethrough into contact with the second side while in a flowable liquid first state during a low-temperature spray transfer process and pressing process, such as discussed above for FIGS. 2A and 2B, and as discussed hereafter with regard to FIG. 7. Thereafter, the binder material 238 is cooled to harden to a solidified second state, whereupon mushroomed flange(s) or flared, enlarged heads 72 (FIG. 5B) of the binder material 238 are formed to overlie and engage the second side of the sheath 240a opposite the body 249 to mechanically interlock the sheath 240a to the body 249, thereby integrating the wire harness 240 and body 249 to form carrier 221. In accordance with another possible configuration, body 249 may be formed having attachment features 77 thereon, either through a high temperature injection molding process or through the lower temperature pressing process described herein, such that in a next assembly step, the wire harness 240 can be attached to the body 249 using the holes 70 receiving the attachment features.

The assembly process for carrier 221, in accordance with a non-limiting aspect of the disclosure, involves inserting the wire harness 240 and body 249 into a specialized tooling system that can stamp and press the assembly of wire harness 240 and body 249 into the carrier 221, for example as shown in FIGS. 2A or 2B. The process is compatible with robotic automation, permitting the entire process to be conducted in a lights-out environment free from human operator involvement. The process may be part of a sequential conveyor layout, such as shown in FIG. 7. Input/Output connectors 74 of wire harness 240 are oriented during manufacturing while pressing the assembly to facilitate autonomous mating, with all mating points accessible in the desired cross-car direction. For example, connectors 74 may be angled in inclined relation with a planar surface of body 249, such as in perpendicular relation to the planar surface of the carrier 221, thereby allowing easy connection of electrical members, such as a window regulator motor 78, a vehicle door speaker 80, and/or side door powered actuators 82, by way of example and without limitation.

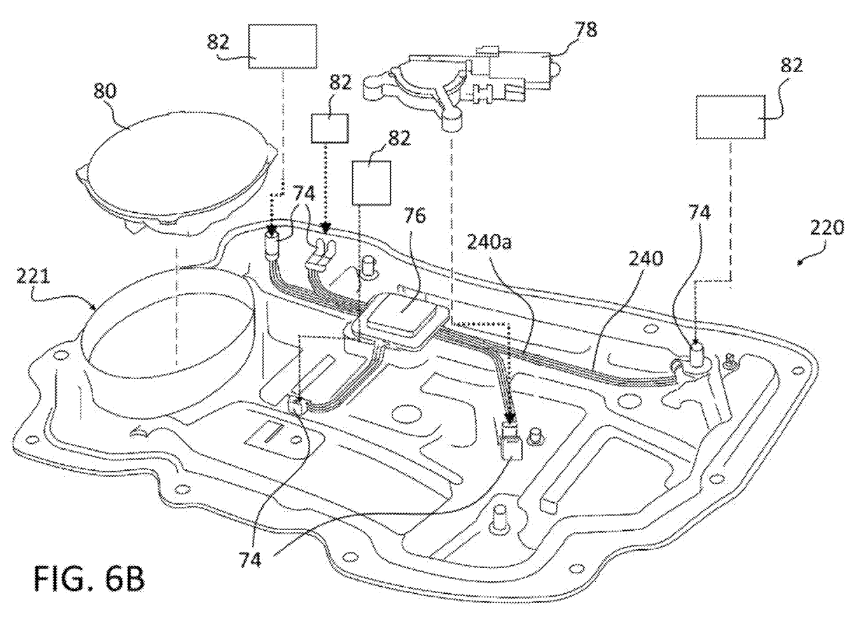

In accordance with another aspect of the disclosure, electronic control modules, such as ECUs (Electronic Control Unit) and/or DCUs (Door Control Unit) 76, for example may be integrated with the substrate, such as shown in FIGS. 6A and 6B, can be integrated directly into the sheath 240a of wire harness 240. Electronic control modules may include in accordance with one possible configuration, a microprocessor and a memory, the microprocessor for executing instructions stored in the memory. The electronic module(s) 76 can be attached to the sheath 240a or embedded and sealed within sheath 240a, such as via being molded within the sheath 240a, thereby forming a single piece wire harness 240 having ECU/DCU 76 integrated therein, thus, further reducing part count and simplifying assembly.

The bonding/connection process of the wire harness 240 to the carrier 221, as discussed above, employs in one illustrative configuration a low-temperature (heated to around 80°C) PU spray applied to the carrier 221, which does not harm sensitive electronic components, such as those discussed above. Once bonded, the wire harness 240 is secured, with the connectors 74 and electronic modules 76 in optimal positions for autonomous installation and mating with other electronic members 78, 80, 82, for example. An advantage of this system is an ability to support unlimited variant configurations, facilitate high-volume autonomous manufacturing, and significantly reduce manual labor and associated costs. Illustratively, as shown in FIG. 5B, part of the carrier 221, e.g. PU binder 238, may at least partially surround the substrate 240a of the wire harness 240 such that when the PU binder 238 hardens as part of its state change from the first state to the second state, the binder material 238 locks the wire harness 240 to body 249. Accordingly, binder material 238, while in the liquidous first state, flows from a bottom side of substrate 240a of the wire harness 240, through apertures 70 in the substrate 240a, and flowingly spills over onto a top side of the substrate 240a such that when the binder material 238 undergoes a state change to the second state and hardens due to cooling or exposure to air, by way of example and without limitation, the new hardened bulbous or flanged shape of the heads 72 of binder material 238 engage with the substrate 240a to lock wire harness 240 in place with substate of body 249.

FIG. 5A shows a possible, non-limiting construction of one of the layers of the wire harness substate 240a which is formed illustratively with wire retention features formed as recessed passages or channels 84 within a plane of the wire harness substrate 240a. The wire retention features 84 have a slight re-entrant, also referred to as undercut, for example, to retain the wiring when snappingly inserted between narrowed opposite sections within the channel or channels 84. The wire harness substrate 240a may be formed as a single layer construction or a double layer construction. The double layer construction may used a vacuum forming process to combine the opposite layers together in lamination with one another to seal the interior e.g. the wiring. In FIG. 6A in accordance with another illustrative example, the vacuum forming process may combine a top substrate layer with a bottom substrate layer to seal the ECU/DCU 76 microcontroller within an enclosed cavity of the wire harness 240, as discussed above. The double layer construction may be used and limited in select regions of the wire harness substrate 240a, thereby only constituting a portion of the wire harness 240 including the controller hub zone housing ECU/DCU 76, wherein the bottom layer, by way of example and without limitation, may have exposed region(s) so that the wiring can be exposed for connection via connectors 74 to electrical components. Connectors 74 may also be configured to extend into an aperture of the body 249 such that the connector terminals are accessible on the dry side when the wire harness 240 extends on the wet side. The binder material PDU against the wire harness substrate 240a may act as a seal between the wet side and dry side.

The door node controller module 76, as an example, as discussed above, can be incorporated within the substrate 240a, with holes 70 within substrate 240a allowing the binder material PU 238 to flow therethrough in the first state to mechanically secure the wire harness 240, including the module 76, after having changed state to the second state as part of a curing or hardening process, for example.

The apertures or holes 70 formed in the wire harness 240 and about the module 76 can be formed as having slots, also referred to as notches 70a, connecting the interior of the aperture 70 to the side or peripheral edge of the substrate 240a, as shown in FIG. 5A. The notches 70a allow some flexibility and play, and/or change in the size and shape of the aperture 70 in the substrate 240a to facilitate the substrate 240a being physically pulled and manipulated to allow the wire harness 240 to removed from the body 249 of carrier 221 and module 220 after installation, such as for recycling of the copper in the wire harness(es) 240, and/or recycling of the carrier body 249. This allows the avoidance of having to physically break the multiple hardened stems or flanged, mushroom-shaped caps 72 of the binder material 238, rather the flexibility and/or geometry of the wire harness substrate 240a facilitates pulling the flexibly separating the wire harness 240 from the carrier body 249. The notches 70a in the substrate 240aconnected to the aperture 70 can also allow the aperture 70 to expand to allow the overlapping, enlarged heads 72 of the binder material 238 to be slide past and through the aperture 70. Further, the stem of the hardened sealer connecting the enlarged head 70 to the main body of the binder material 238 can be passed slidingly through the open notch 70a in the substrate 240a.

Now referring to FIG. 7, there is shown an assembly process 1000, by way of example and without limitation, of the carrier/module 221, 220 having a carrier body 249 with integrated wire harness 240 formed as part of a continuous conveyor system. As an input to the assembly system, a first step 1100 may be to provide a (e.g. continuous stream) of body material 249 which may be from a role of environmentally sustainable material (e.g. formed from jute, basalt or hemp material). Optionally the continuous stream of the body material 249 may be outputted directly into the processing flow from a machine that forms the continuous sheet of body material 249. Alternatively, precut, discrete sheets of body material 249 may be provided. Accordingly, body material 249 can be provided from a machine as a roll forming a continuous stream of material, or as precut sheets, and then, is next conveyed to a step 1200 of coating the material with a binding material, such as a binding agent 238 in a liquidous first state that can harden to a solidified second state during a state change. Such an agent may be a binder, adhesive, sealant such that the sheet of material 249 is supplied as wet to the next stage of processing, illustratively a press.

As part of the next step 1300, positioning of the material 249 with liquid binder material 238 thereon inside a press is provided. The wire harness 240, as described herein above, is also positioned inside the press. Next, closing of the press to secure the wire harness 240 with the body 249 of carrier/module is performed. The press is not an injection molding press, but a low-temperature (70-90 ^{o}C) stamping press which is used to form the sheet of material 249 and cause the binding agent 238 to surround at least a part of the substrate 240a of the wire harness 240. After the pressing operation is complete, the agent cures to change state from being fluid to being solid, thereby causing the binder material 238 to harden around the substrate 240a of the wire harness 240. The sheet of body material 249, now being formed with the attached wire harness 240, is moved to the next operation 1400, including a punch press, for example. In the punch press operation 1400, forming or cutting the body material 249 into the finished carrier shape is provided, e.g. separate the finished carrier shape of body material 249 from the unneeded sheet material, and further including punching holes in the carrier body material 249 for fastener points. The formed carrier body 249, having the mechanically secured wire harness 240 is next removed from the assembly line 1000. There is no injection molding process used in the connection of the wire harness 240 to the body 249 of carrier 221 or module 220. The carrier 221 and module 220 therewith is formed during the pressing 1300 and punching 1400, e.g. which may include a low temperature, but does not include an injection molding process, which typically includes high temperatures that would cause damage to the wires of the wire harness 240 and to the substrate 240a and also to the ECU/DCU 76. The connection of the wire harness 240 to the body 249 of door module 220 may occur during the formation of the carrier 221 of door module 220, e.g. during the stamping process 1300 forming the features of the carrier/module, and not after the door module has been formed, e.g. after the door module has been removed from an injection molding machine as known in prior methods of forming a carrier/module.

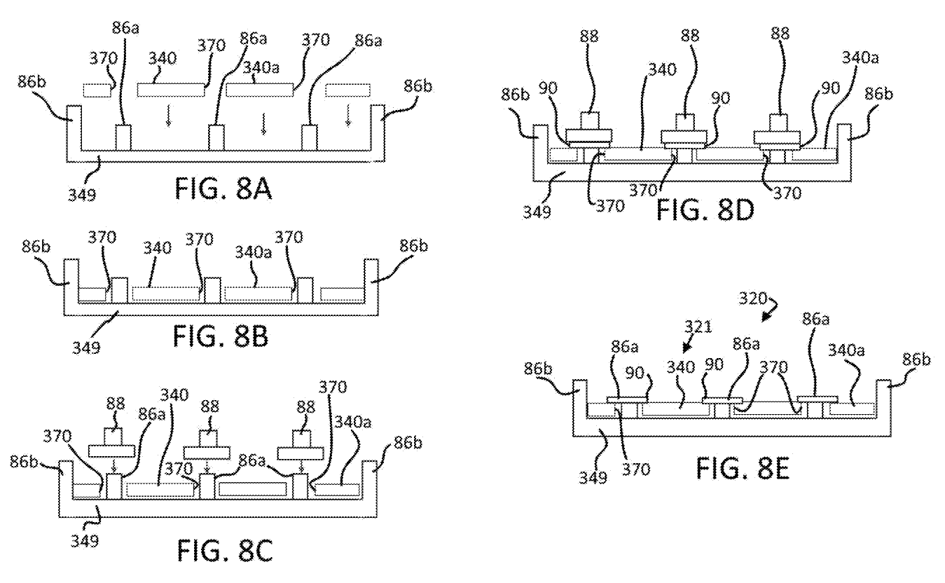

Now referring to FIGS. 8A through 8E, in accordance with another aspect of the disclosure, there is shown a process of making a carrier 321 of a carrier module 320 having a wire harness 340 installed in attachment with a carrier body 349 after the carrier body 349 is preformed, such as in an injection molded process. As part of this injection molding process, binder material, also referred to as attachment features 86a, and attachment guides 86b may be pre-formed on the carrier body 349 in order to assist with the securing of the wire harness 340 to the carrier 321 and carrier module 320. As part of the securing/attachment process, after the carrier 321 of carrier module 320 has been formed, such as in the injection molding processes, by way of example and without limitation, the wire harness 340 may be guided along attachment guides 86b to align apertures, also referred to as openings or holes 370 within a substrate 340a of wire harness 340 with the attachment features 86a, as shown in FIG. 8A and 8B. Upon bringing a first side of the substrate 340a, facing the carrier body 349, into engagement with the carrier body 349, the attachment features 86a are manipulated to undergo a change in shape, such as via undergoing a state change from a solid state, to a melted state, whereupon the shape change is implemented, and back to a solid state, whereupon the implemented shape change is retained. For example, the attachment features 86a are heated sufficiently to soften and pressed via a press tool 88 (FIGS. 8C and 8D), thereby causing the material of the attachment features 86a to flow over and into bonded contact with a second side of the substrate 340a, facing away from the carrier body 349, so as to form an enlarged head, also referred to as flange 90, that overlies and surrounds at least part of the second side, also referred to as upper surface, of the substrate 340a of the wire harness 340 (FIGS. 8D and 8E). Then, once the heat source is removed and the newly shaped attachment features 86a harden, the wire harness 340 is locked with the carrier 321 of carrier module 320(FIG. 8E). As shown in FIG. 8E, the attachment features 86a extend through the apertures 370 in the substrate 340a of wire harness 340, with the material of attachment features 86a having experienced the stated change in shape forming the flanges 90 over the top of the substrate 340a of wire harness 340 to lock the substrate 340a of wire harness 340 with the carrier 321 of carrier module 320.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways.

Such variations are not to be regarded as a departure from the disclosure, and all such modifications are intended to be included within the scope of the disclosure.

What is claimed is:

1. A carrier for a carrier module of a motor vehicle door assembly having an inner panel and an outer panel defining a door panel structure with the inner panel having an opening to an internal door cavity between the inner and outer panels, said carrier comprising:
a body with opposite sides bounded by an outer periphery configured for attachment to the inner panel to substantially close off the opening;
a binder bonded to at least one of the opposite sides; and
at least one wire fixed to said body by the binder.

2. The carrier of claim 1, wherein the body is formed of a sustainable material.

3. The carrier of claim 1, wherein the at least one wire is entirely encapsulated beneath an exposed surface of the binder, with the exception of at least one location where the at least one wire is electrically connected to an electrical component.

4. The carrier of claim 3, wherein the at least one wire is not visible, with the exception in the at least one location where the at least one wire is electrically connected to the electrical component.

5. The carrier of claim 3, wherein the body has an undulating contour, including a plurality of recessed pockets, wherein the at least one wire follows the undulating contour in embedded relation with the binder.

6. The carrier of claim 5, wherein the at least one wire follows a generally straight path along the undulating contour.

7. The carrier of claim 1, wherein the at least one wire is carried by a substrate, wherein the binder is bonded to the substrate.

8. The carrier of claim 7, wherein the substrate has a first surface facing the body and a second surface facing away from the body, a plurality of holes extend through the substrate, and the binder extends through the holes into engagement with the second surface.

9. The carrier of claim 8, wherein the binder forms enlarged heads in engagement with the second surface.

10. The carrier of claim 8, wherein notches extend from an outer periphery of the substrate to the holes.

11. The carrier of claim 7, further including a control unit embedded with the substrate, the control unit arranged in electrical communication with the at least one wire.

12. The carrier of claim 1, further comprising an electrical connector extending from the at least one wire to facilitate connection to an electronic component.

13. A carrier for a carrier module of a motor vehicle door assembly, said carrier comprising:
a body for supporting at least one hardware component;
where a portion of the body undergoes a state change from a first state where the at least one hardware component is positionable into contact with the portion to a second state where the hardware component is secured in place to the body by the portion.

14. The carrier of claim 13, wherein the at least one component includes a wire harness having a substrate, wherein the substrate has a first side facing the body and a second side facing away from the body, a plurality of holes extend through the substrate, and the portion of the body extends through the holes into engagement with the second side.

15. The carrier of claim 14, wherein the portion of the body forms a flange that overlies and engages the second side of the substrate.

16. A method of forming a carrier for a vehicle, comprising:
supplying a body of material;
supplying a hardware component;
applying an agent to at least one of the body of material and the hardware component;
positioning the hardware component and the body of material in a press; and
bringing the body of material, the hardware component and the agent together using the press when the agent is in a first state; and
changing the state of the agent from the first state to a second state to secure the hardware component to the body of material.

17. The method of claim 16, further including pressing the body of material and the hardware component between a pair of plates and causing the body of material to attain a non-planar contour.

18. The method of claim 17, further including heating the body of material and the agent between the pair of plates to a temperature between about 70-90 ^{o}C.

19. The method of claim 17, further including providing the hardware component as a wire harness including a substrate having a first side facing the body of material and a second side facing away from the body of material, the substrate having a plurality of holes, and causing the agent to flow through the plurality of holes while in the first state and solidifying the agent in engagement with the second side while in the second state.

20. The method of claim 19, further including forming solidified flanges of the agent in engagement with the second side of the substrate while in the second state.
